(19) United States
(12) Patent Application Publication
(10) Pub. No.: US 2026/0045414 A1
(43) Pub. Date: Feb. 12, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Wonggi Kang, Suwon-si (KR); Eun Cho, Suwon-si (KR); Jihyun Lee, Suwon-si (KR); Taeyoon Kim, Suwon-si (KR); Byung Hyun Park, Suwon-si (KR); Hyungjoon Jeon, Suwon-si (KR); Jeong Ryeol Kim, Suwon-si (KR)

(73) Assignee: SAMSUNG ELECTRO-MECHANICS CO., LTD., Suwon-si (KR)

(21) Appl. No.: 19/012,762

(22) Filed: Jan. 7, 2025

(30) Foreign Application Priority Data
Aug. 9, 2024 (KR) 10-2024-0106549

(51) Int. Cl. H01G 4/12; H01G 4/30

(52) U.S. Cl. CPC H01G 4/1227; H01G 4/30

(57) ABSTRACT

A multilayer ceramic capacitor and a method of manufacturing the multilayer ceramic capacitor including a capacitor body including a dielectric layer and an internal electrode layer, and an external electrode disposed on the outside of the capacitor body, wherein the dielectric layer includes a plurality of dielectric grains, grain boundaries disposed between the plurality of dielectric grains, and a triple point where three grain boundaries are disposed in contact, and the dielectric layer includes a secondary phase disposed at the triple point and including Dy, Al, and Si.

### CROSS-REFERENCE TO RELATED APPLICATION

This application claims priority to and the benefit of Korean Patent Application No. 10-2024-0106549 filed in the Korean Intellectual Property Office on Aug. 9, 2024, the entire contents of which are incorporated herein by reference.

### BACKGROUND

### (a) Technical Field

The present disclosure relates to a multilayer ceramic capacitor and a manufacturing method thereof.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, as multilayer ceramic capacitors are used in various fields such as IT and electrical fields, securing more severe temperature characteristics is required.

### SUMMARY

An embodiment provides a multilayer ceramic capacitor having excellent high-temperature TCC (temperature change in capacitance) characteristics and reliability.

Another embodiment provides a method of manufacturing a multilayer ceramic capacitor.

An embodiment provides a multilayer ceramic capacitor including a capacitor body including a dielectric layer and an internal electrode layer, and an external electrode disposed on an outside of the capacitor body, wherein the dielectric layer includes a plurality of dielectric grains, grain boundaries disposed between the plurality of dielectric grains, and a triple point where three grain boundaries are disposed in contact, the dielectric layer includes a secondary phase disposed at the triple point, and the secondary phase includes Dy, Al, and Si.

The secondary phase may include Dy in an amount of about 15 atomic % to about 25 atomic % based on a total amount of atoms in the secondary phase.

The secondary phase may include Al in an amount of about 5 atomic % to about 6 atomic % based on a total amount of atoms in the secondary phase.

The secondary phase may include Si in an amount of about 70 atomic % to about 80 atomic % based on a total amount of atoms in the secondary phase.

The dielectric layer may include a main component of barium titanate and a subcomponent including Dy, Al, and Si.

The subcomponent may further include one or more elements selected from Tb, V, Mn, and Mg.

Dy of the secondary phase may be included in the dielectric layer in an amount of about 0.95 parts by atom to about 1.15 parts by atom based on 100 parts by atom of Ti in the barium titanate-based main component.

Al of the secondary phase may be included in the dielectric layer in an amount of about 0.30 parts by atom to about 0.34 parts by atom based on 100 parts by atom of Ti in the barium titanate-based main component.

Si of the secondary phase may be included in the dielectric layer in an amount of about 4.0 parts by atom to 4.4 parts by atom based on 100 parts by atom of Ti in the barium titanate-based main component.

An area occupied by the secondary phase may be about 0.15% to about 1% of a total area of the dielectric layer.

In the secondary phase, an amount of Al may be less than an amount of Dy.

In the secondary phase, an amount of Al may be less than an amount of Si.

In the secondary phase, an amount of Dy less than an amount of Si.

Another embodiment provides a method of manufacturing a multilayer ceramic capacitor which includes: mixing a barium titanate-based main component powder and a subcomponent powder including a Dy-containing compound, an Al-containing compound, and a Si-containing compound to prepare a dielectric slurry; manufacturing a dielectric green sheet from the dielectric slurry and forming a conductive paste layer on a surface of the dielectric green sheet; manufacturing a dielectric green sheet stack by stacking a plurality of the dielectric green sheets on which the conductive paste layer is formed; manufacturing a capacitor body including a dielectric layer and an internal electrode layer by firing the dielectric green sheet stack; and forming an external electrode on a surface of the capacitor body, wherein the dielectric layer includes a plurality of dielectric grains, grain boundaries disposed between the plurality of dielectric grains, and a triple point where three grain boundaries are disposed in contact, the dielectric layer includes a secondary phase disposed at the triple point, and the secondary phase includes Dy, Al, and Si.

The Dy-containing compound may be mixed in an amount of about 0.5 parts by mole to about 1.2 parts by mole based on 100 parts by mole of the barium titanate-based main component powder.

The Al-containing compound may be mixed in an amount of about 0.1 parts by mole to about 0.5 parts by mole based on 100 parts by mole of the barium titanate-based main component powder.

The Si-containing compound may be mixed in an amount of about 1 part by mole to about 5 parts by mole based on 100 parts by mole of the barium titanate-based main component powder.

The subcomponent powder may further include at least one selected from a Tb-containing compound, a V-containing compound, a Mn-containing compound, and a Mg-containing compound.

The firing may be performed under a holding time of about 10 seconds to about 3 minutes.

The firing may be performed at a temperature of about 1160° C. to about 1250° C.

The multilayer ceramic capacitor according to an embodiment can improve high-temperature TCC (temperature change in capacitance) characteristics while maintaining high reliability by suppressing solid-solution of additives to a barium titanate-based dielectric.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure of the internal electrode layers in the capacitor body of FIG. 1.

FIG. 5 is a schematic view showing a cross-section of a dielectric layer according to an embodiment.

FIGS. 6A to 6D are TEM-EDS (transmission electron microscope-energy dispersive spectroscopy) analysis images of a dielectric layer according to Example 1.

FIGS. 7A to 7D are TEM-EDS (transmission electron microscope-energy dispersive spectroscopy) analysis images of a dielectric layer according to Comparative Example 1.

FIG. 8 is a graph of the temperature coefficient of capacitance (TCC) of the multilayer ceramic capacitors according to Example 1, Comparative Example 1, and Comparative Example 2.

FIG. 9 is a graph showing the high-temperature stress reliability of a multilayer ceramic capacitor according to Example 1.

FIG. 10 is a graph showing the high-temperature harsh reliability of the multilayer ceramic capacitor according to Comparative Example 1.

FIG. 11 is a graph showing the high-temperature stress reliability of a multilayer ceramic capacitor according to Comparative Example 2.

FIG. 12 is a graph showing the moisture resistance reliability of a multilayer ceramic capacitor according to Example 1.

FIG. 13 is a graph showing the moisture resistance reliability of a multilayer ceramic capacitor according to Comparative Example 1.

FIG. 14 is a graph showing the moisture resistance reliability of a multilayer ceramic capacitor according to Comparative Example 2.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

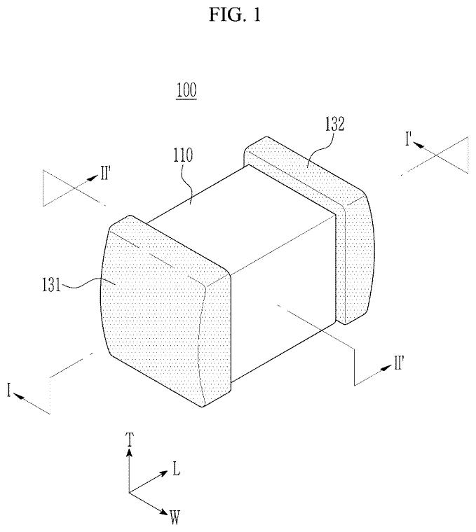

Hereinafter, a multilayer ceramic capacitor according to an embodiment will be described with reference to FIGS. 1 to 4.

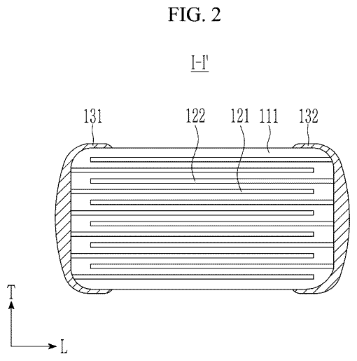

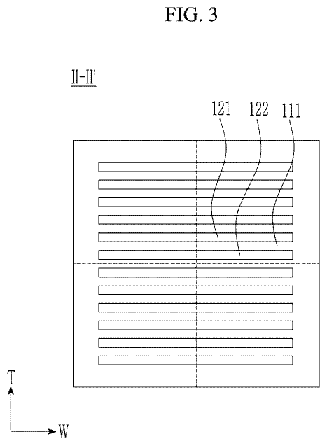

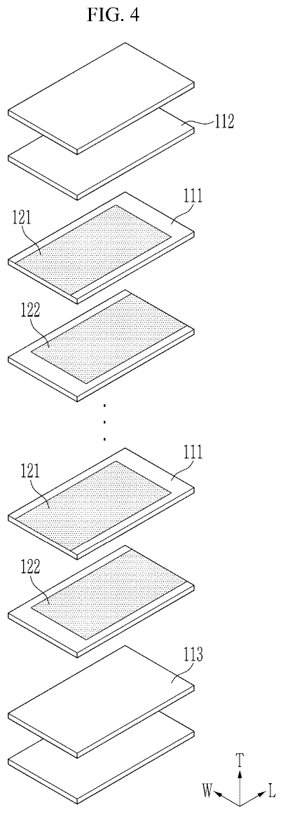

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure of the internal electrode layers in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed outside the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately disposed, which contributes to forming capacitance of the multilayer ceramic capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be positioned on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be located on opposite side ends of the active region in the width direction (W-axis direction), that is, on the fifth surface and the sixth surface, respectively. The side margin region may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin area serve to prevent damage to the first internal electrode layer 121 and the second internal electrode layer 122 due to physical or chemical stress.

Hereinafter, each of the dielectric layer, internal electrode layer, and external electrode is described in detail.

### Dielectric Layer

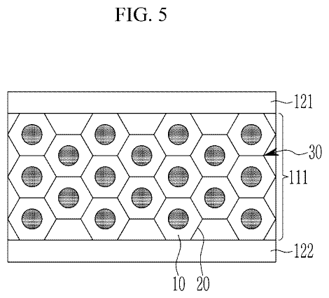

The dielectric layer is explained with reference to FIG. 5.

FIG. 5 is a schematic view showing a cross-section of a dielectric layer according to an embodiment.

Referring to FIG. 5, the dielectric layer 111 may include a plurality of dielectric grains 10, a grain boundary 20 disposed among the plurality of dielectric grains 10, and a triple point 30 where the three grain boundaries 20 are disposed in contact. The triple point 30 refers to a point where three grain boundaries 20 meet one another and may be at least one in the dielectric layer.

The dielectric layer 111 according to an embodiment may include a secondary phase disposed in the triple point 30. Herein, the secondary phase may include dysprosium (Dy), aluminum (Al), and silicon (Si) elements.

The secondary phase may refer to a new phase precipitated after firing the dielectric green sheet stack. In other words, if the dielectric green sheet stack obtained by using a dielectric slurry prepared by mixing a barium titanate-based main component and a subcomponent corresponding to an additive is fired, the additive such as a rare earth element may be not solid solved into a barium titanate lattice but precipitated in a form of the secondary phase.

In addition, Dy, Al, and Si included in the secondary phase are each chemically combined and present in the form of a compound.

If more than one triple point 30 exists in the dielectric layer, the secondary phase may be included in at least one among the plurality of triple points 30.

As a content of the additive, for example, a rare earth element such as Dy and the like, which is added with the barium titanate-based main component in order to form a dielectric layer, is increased, because temperature characteristics such as a temperature coefficient of capacitance (TCC) may be increasingly deteriorated, but there is an effect of improving reliability, it is difficult to simply reduce the content of the additive. Accordingly, an embodiment is not to reduce the content of the additive but to improve temperature characteristics such as TCC characteristics, while still maintaining reliability characteristics through a solid-solution difference of the additive in the barium titanate-based main component. That is, according to an embodiment, when a secondary phase including Dy, Al, and Si is located at the triple point 30 within the dielectric layer 111, high-temperature TCC (capacitance change rate) characteristics can be improved while maintaining high reliability by suppressing solid-solution of additives in the barium titanate dielectric.

Whether or not the secondary phase including Dy, Al and Si exists at the triple point 30 in the dielectric layer 111 may be checked through TEM-EDS (transmission electron microscope-energy dispersive spectroscopy) analysis. Other methods and/or tools appreciated by one of ordinary skill in the art, even if not described in the present disclosure, may also be used.

In more detail, after the multilayer ceramic capacitor 100 was placed into the epoxy mixture liquid and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, the active area of the cross-sectional sample can be measured using a transmission electron microscope (TEM) so that at least one layer of the dielectric layer 111, for example, one to five layers, are visible. For example, TEM can be measured under conditions of an acceleration voltage of 200 kV using a Xe-FIB (focused ion beam) in an area of about 400 nm×400 nm in which at least one dielectric layer 111 is visible in the active area. Next, by performing EDS (energy dispersive spectroscopy) analysis on the TEM image of the measured cross-sectional sample, it can be confirmed that a secondary phase including Dy, Al, and Si exists at the triple point, which is the point where three arbitrary grain boundaries meet within the dielectric layer 111.

The dysprosium (Dy) included in the secondary phase may be included in an amount of about 15 atomic % to about 25 atomic % based on a total amount of atoms in the secondary phase, for example, about 17 atomic % to about 23 atomic %, about 18 atomic % to about 22 atomic %, or about 19 atomic % to about 21 atomic %. When the Dy content is within the ranges in the secondary phase, solid-solution of the additive in the barium titanate dielectric material may be suppressed, thereby improving high-temperature TCC characteristics as well as maintaining excellent reliability characteristics.

Aluminum (Al) included in the secondary phase may be included in an amount of about 5 atomic % to about 6 atomic % based on the total amount of atoms in the secondary phase, for example, about 5.1 atomic % to about 5.9 atomic %, about 5.2 atomic % to about 5.8 atomic %, or about 5.3 atomic % to about 5.7 atomic %. In the secondary phase, if the Al content is within the ranges, solid-solution of the additive in the barium titanate dielectric material may be suppressed, thereby improving high-temperature TCC characteristics as well as maintaining excellent reliability characteristics.

Silicon (Si) included in the secondary phase may be included in amount of about 70 atomic % to about 80 atomic % based on the total amount of atoms in the secondary phase, for example, about 72 atomic % to about 78 atomic %, about 73 atomic % to about 77 atomic %, or about 74 atomic % to about 76 atomic %. In the secondary phase, if the Si content is within the ranges, solid-solution of the additive in the barium titanate dielectric material may be suppressed, thereby improving high-temperature TCC characteristics as well as maintaining excellent reliability characteristics.

The dielectric layer 111 may include a barium titanate-based main component and subcomponent.

The barium titanate-based main component is a dielectric matrix, has a high dielectric constant, and contributes to forming the dielectric constant of a multilayer ceramic capacitor 100.

The barium titanate-based main component powder is a compound containing barium (Ba) and titanium (Ti), and may include, for example, BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

The subcomponent may include Dy, Al, and Si. The subcomponent is distinct from the secondary phase present at the triple point 30 and may be present in at least either one of the dielectric grain 10 and the grain boundary 20 in the dielectric layer 111.

The subcomponent may further include one or more elements selected from terbium (Tb), vanadium (V), manganese (Mn), and magnesium (Mg).

Dy included in the secondary phase may be included in an amount of about 0.95 parts by atom to about 1.15 parts by atom based on 100 parts by atom of Ti in the barium titanate-based main component in the dielectric layer 111, for example, about 0.98 parts by atom to about 1.12 parts by atom or about 1.0 parts by atom to about 1.10 parts by atom. If the Dy content of the secondary phase in the entire dielectric layer is within the ranges, solid-solution of the additive in the barium titanate dielectric material may be suppressed, thereby improving high-temperature TCC characteristics as well as maintaining excellent reliability characteristics.

Al included in the secondary phase may be included in an amount of about 0.30 parts by atom to about 0.34 parts by atom based on 100 parts by atom of Ti in the barium titanate-based main component in the dielectric layer 111, for example, about 0.31 parts by atom to about 0.33 parts by atom. If the Al content in the secondary phase in the entire dielectric layer is within the ranges, solid-solution of the additive in the barium titanate dielectric material may be suppressed, thereby improving high-temperature TCC characteristics as well as maintaining excellent reliability characteristics.

Si included in the secondary phase may be included in an amount of about 4.0 parts by atom to about 4.4 parts by atom based on 100 parts by atom of Ti in the barium titanate-based main component in the dielectric layer 111, for example, about 4.1 parts by atom to about 4.3 parts by atom. In the entire dielectric layer, if the Si content in the secondary phase is within the ranges, solid-solution of the additive by the barium titanate dielectric material may be suppressed, thereby improving high-temperature TCC characteristics as well as maintaining excellent reliability characteristics.

In the dielectric layer 111, an area taken by the secondary phase may be about 0.15% to about 1% of a total area of the dielectric layer, for example, about 0.18% to about 0.9%, about 0.2% to about 0.8%, or about 0.25% to about 0.7%. The total area of the dielectric layer may be, for example, in a range of about 400 nm±about 200 nm×about 400 nm±about 200 nm.

Each Dy, Al, and Si content and the area of the secondary phase in the dielectric layer may be confirmed through a TEM-EDS (transmission electron microscope-energy dispersive spectroscopy) analysis. Other methods and/or tools appreciated by one of ordinary skill in the art, even if not described in the present disclosure, may also be used.

An average thickness (average length in the T-axis direction) of the dielectric layer 111 may be about 2.0 μm to about 8.0 μm, and for example, may be about 0.1 μm to about 6.0 μm. When the average thickness of the dielectric layer 111 is within the above range, the reliability of the multilayer ceramic capacitor may be improved.

The average thickness of the dielectric layer 111 may be measured by placing the multilayer ceramic capacitor 100 in an epoxy mixing solution, curing it, polishing it, and then ion milling it, and then analyzing it using a scanning electron microscope (SEM). A scanning electron microscope can be used, for example, using a Verios G4 product from Thermofisher Scientific, with measurement conditions of 10 kV and 0.2 nA, an analysis magnification of 100 times, and may be measured for at least 1 layer, 3 layers, 5 layers, or 10 layers or more of dielectric layers 111. This may be an arithmetic mean value obtained by taking the central point of the length direction (L-axis direction) or width direction (W-axis direction) of the dielectric layer 111 as a reference point in a scanning electron microscope (SEM) image of a cross-sectional sample measured as described above, and taking the arithmetic mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted.

### Internal Electrode Layer

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The first internal electrode layer 121 and the second internal electrode layer 122 include a conductive metal, and may include, for example, a metal such as Ni, Cu, Ag, Pd, Au, or an alloy thereof, for example, an Ag—Pd alloy.

Additionally, the first internal electrode layer 121 and the second internal electrode layer 122 may include dielectric particles having the same composition as the ceramic material included in the dielectric layer 111.

The first internal electrode layer 121 and the second internal electrode layer 122 may be formed using a conductive paste including a conductive metal. The printing method for the conductive paste may be either screen printing or gravure printing.

Each average thickness of the first internal electrode layer 121 and the second internal electrode layer 122 may be about 0.1 μm to about 2 μm. The average thickness of the first internal electrode layer 121 and the second internal electrode layer 122 may be measured by scanning electron microscope (SEM) analysis. Here, the scanning electron microscope (SEM) analysis is the same as the method used to measure the average thickness of the dielectric layer 111 described above, so its description is omitted.

The capacitor body 110 may be formed by firing a stacking structure in which the plurality of dielectric layers 111 and internal electrode layers 121 and 122 are stacked.

### External Electrode

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

Each of the first external electrode 131 and the second external electrode 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include copper (Cu), nickel (Ni), silver (Ag), palladium (Pd), gold (Au), platinum (Pt), tin (Sn), tungsten (W), titanium (Ti), lead (Pb), an alloy thereof, or a combination thereof, and for example, the term copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the first internal electrode layer 121 and the second internal electrode layer 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. Flake shape powder refers to a powder with a flat and elongated shape, and is not particularly limited. But for example, the length ratio of the major axis and the minor axis (major axis/minor axis) may be greater than or equal to about 1.95.

The first external electrode 131 and the second external electrode 132 may further include the plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer ceramic capacitor 100.

### Method of Manufacturing Multilayer Ceramic Capacitor

Hereinafter, a method of manufacturing the multilayer ceramic capacitor 100 according to an embodiment will be described.

A multilayer ceramic capacitor 100 according to an embodiment may be manufactured by mixing a barium titanate-based main component powder and a subcomponent powder including a Dy-containing compound, an Al-containing compound, and a Si-containing compound to prepare a dielectric slurry; manufacturing a dielectric green sheet using the dielectric slurry and forming a conductive paste layer on the surface of the dielectric green sheet; manufacturing a dielectric green sheet stack by stacking the dielectric green sheet in which the conductive paste layer is formed; manufacturing a capacitor body including a dielectric layer and an internal electrode layer by firing the dielectric green sheet stack; and forming an external electrode on a surface of the capacitor body.

The barium titanate-based main component powder is a compound containing barium (Ba) and titanium (Ti), and may include, for example, BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

The Dy-containing compound, the Al-containing compound and the Si-containing compound may each be an oxide, a nitride or a salt compound, or may be used in the form of a sol dispersed in an organic solvent.

The Dy-containing compound may be mixed in an amount of about 0.5 parts by mole to about 1.2 parts by mole, for example about 0.6 parts by mole to about 1.1 parts by mole, or about 0.7 parts by mole to about 1.0 part by mole based on 100 parts by mole of the barium titanate-based main component powder. If the Dy-containing compound is mixed within the content ranges, formation of the secondary phase may be induced and thus suppress solid-solution of the additive in the barium titanate dielectric material, thereby improving high-temperature TCC characteristics as well as maintaining high reliability.

The Al-containing compound may be mixed in an amount of about 0.1 parts by mole to about 0.5 parts by mole based on 100 parts by mole of the barium titanate-based main component powder, for example, about 0.2 parts by mole to about 0.4 parts by mole. If the Al-containing compound is mixed within the content ranges, formation of the secondary phase may be induced and thus suppress solid-solution of the additive in the barium titanate dielectric material, thereby improving high-temperature TCC characteristics as well as maintaining high reliability.

The Si-containing compound may be mixed in an amount of about 1 part by mole to about 5 parts by mole based on 100 parts by mole of the barium titanate-based main component powder, for example, about 1.5 parts by mole to about 4.5 parts by mole, or about 2 parts by mole to about 4 parts by mole. If the Si-containing compound is mixed within the content ranges, formation of the secondary phase may be induced and thus suppress solid-solution of the additive in the barium titanate dielectric, thereby improving high-temperature TCC characteristics as well as maintaining high reliability.

The subcomponent component powder may further include at least one selected from a Tb-containing compound, a V-containing compound, a Mn-containing compound, and a Mg-containing compound.

The dielectric slurry may be prepared by additionally mixing additives such as a dispersant, a binder, a plasticizer, a lubricant, an antistatic agent, and a solvent.

The dispersant may include for example a phosphoric acid ester-based dispersant, a polycarboxylic acid-based dispersant, or a combination thereof. The dispersant may be mixed in an amount of about 0.1 part by weight to about 5 parts by weight, for example, about 0.3 parts by weight to about 3 parts by weight based on 100 parts by weight of the barium titanate-based compound. When the dispersant is mixed within the above content range, the dielectric slurry shows excellent dispersibility, and the amount of impurities included in the manufactured dielectric layer may be reduce.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

To form a conductive paste layer that becomes an internal electrode layer after firing, a conductive paste may be prepared by mixing a conductive powder made of a conductive metal or an alloy thereof, a binder, and a solvent. Additionally, a barium titanate powder may be mixed in as a co-material if necessary. The co-material may act to suppress sintering of the conductive powder during the firing process. In the step of manufacturing the dielectric green sheet, a dielectric slurry may be prepared by mixing a barium titanate-based compound as a main component powder and optionally a subcomponent powder.

The conductive powder may include nickel (Ni) or a nickel (Ni) alloy.

Next, a dielectric green sheet stack is prepared by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be prepared after binder removal treatment (plasticizing) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1160° C. to about 1250° C., for example, at a temperature of about 1180° C. to about 1240° C., about 1190° C. to about 1230° C., or about 1200° C. to about 1220° C. Additionally, the firing may be performed under a holding time of about 10 seconds to about 3 minutes, for example, under a holding time of about 20 seconds to about 2.5 minutes, about 30 seconds to about 2 minutes, or about 40 seconds to about 1.5 minutes. Additionally, the firing may be performed in a reducing atmosphere, for example, in a humidified mixed gas of nitrogen and hydrogen, and may be performed under conditions such as a hydrogen concentration of less than or equal to about 1.0%. When the internal electrode layer includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer is formed on the outside of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Example 1

Barium titanate (BaTiO₃) primary component powder was mixed with subcomponent powder such as 1 part by mole of dysprosium oxide (Dy₂O₃), 0.3 parts by mole of aluminum oxide (Al₂O₃), and 3 parts by mole of silicon dioxide (SiO₂) based on 100 parts by mole of the barium titanate (BaTiO₃) to prepare dielectric slurry.

In the preparation of the dielectric slurry, mixing was performed by using zirconia balls (ZrO₂ balls) as a dispersion medium, adding ethanol/toluene and polyvinyl butyral (PVB) resin as a wetting dispersant and binder, and then mechanically milling.

Subsequently, the dielectric slurry was used by using a head discharge type on-roll forming coater to manufacture a dielectric green sheet.

A conductive paste layer including nickel (Ni) was printed on the surface of a dielectric green sheet, and the dielectric green sheets on which the conductive paste layers were formed were stacked and pressed to manufacture a dielectric green sheet stack.

The dielectric green sheet stack was calcined under a sintering process at a temperature of 400° C. or less in a nitrogen atmosphere, and was calcined at a sintering temperature of 1210° C. and a holding time of 51 seconds under conditions of a hydrogen concentration of 0.11%.

Subsequently, the dielectric green sheet stack was used to manufacture a multilayer ceramic capacitor through processes of an external electrode, plating, or the like.

### Comparative Example 1

A multilayer ceramic capacitor was manufactured in the same manner as in Example 1 except that the firing was performed at a firing temperature of 1140° C. for a holding time of 5 minutes at a hydrogen concentration 0.11%.

### Comparative Example 2

A multilayer ceramic capacitor was manufactured in the same manner as in Example 1 except that the firing was performed at a firing temperature of 1140° C. for a holding time of 4 minutes at a hydrogen concentration 0.11%.

### Evaluation 1: TEM-EDS Analysis

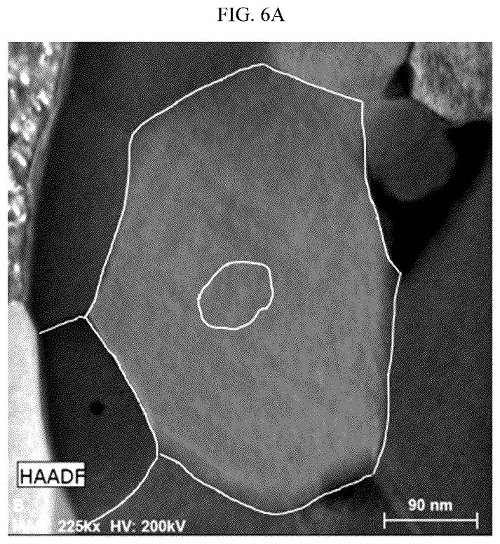

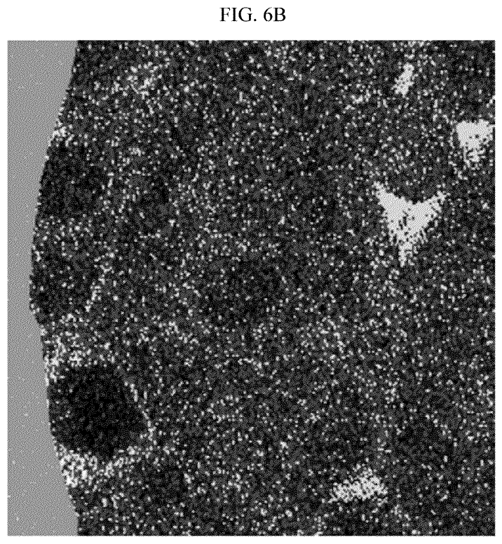

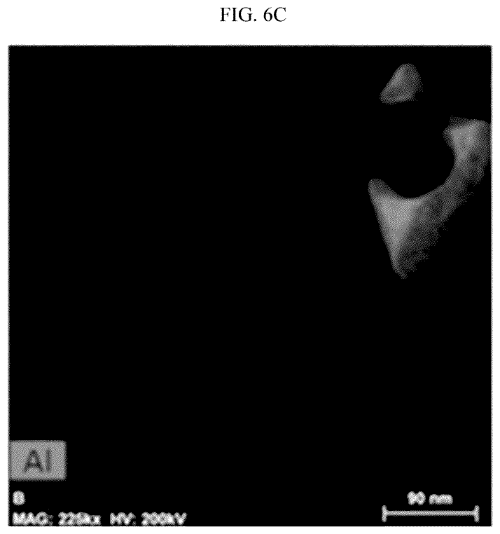

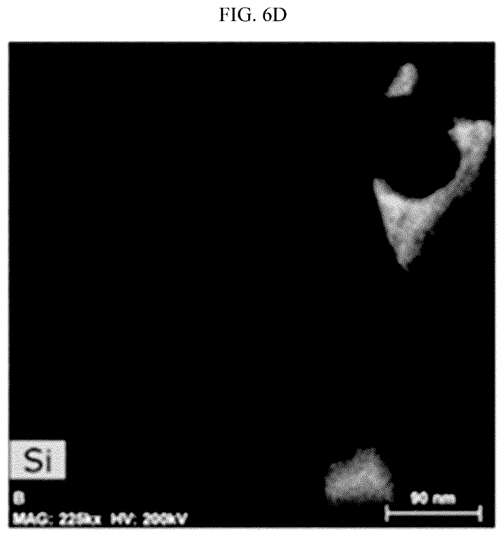

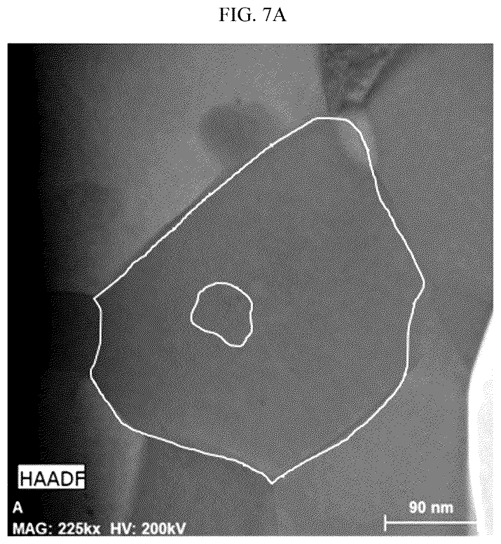

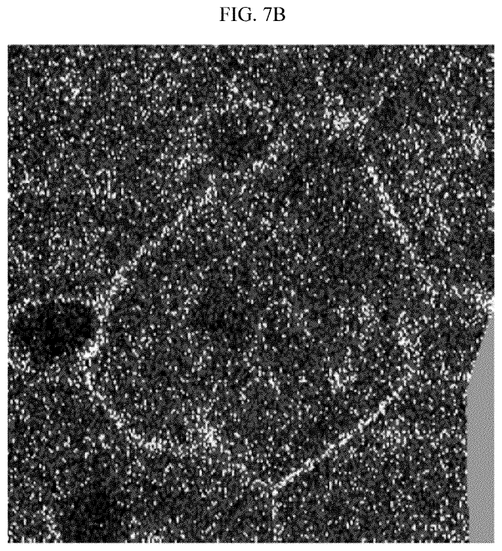

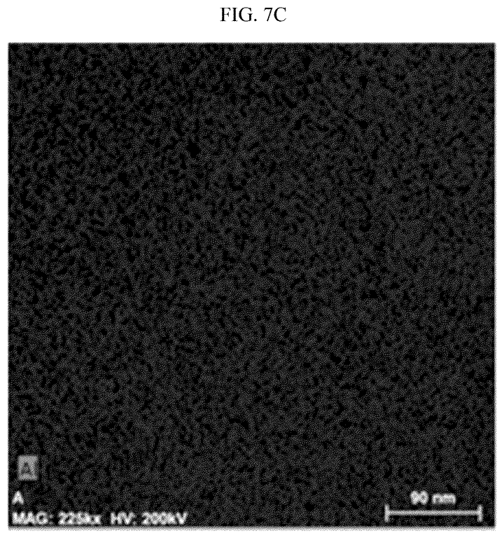

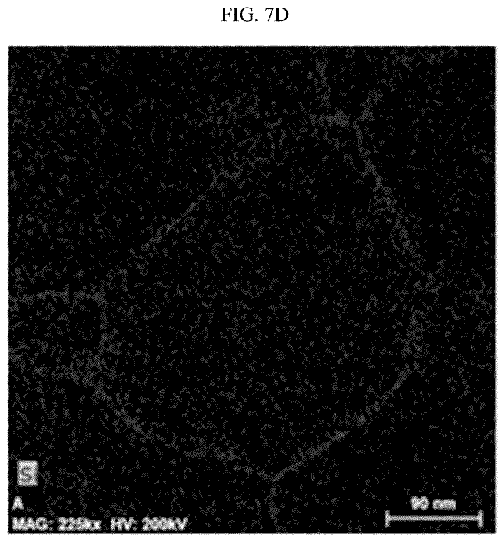

TEM-EDS (transmission electron microscopy-energy dispersive spectroscopy) analysis was performed on the multilayer ceramic capacitors manufactured in Example 1 and Comparative Example 1, and the results are shown in FIGS. 6A to 6D and 7A to 7D.

Specifically, the cross-sectional samples were obtained such that the active region where the dielectric layer and the internal electrode layer intersect may be observed, as the multilayer ceramic capacitors manufactured in Example 1 and Comparative Example 1 were placed into an epoxy mixture liquid and cured, the W-axis and T-axis direction surface (WT surface) of the capacitor body were polished to a depth of ½ in the L-axis direction, and then it were fixed and maintained in a vacuum atmosphere chamber. Next, the active region of the cross-sectional sample can be measured using a scanning electron microscope (SEM) so that at least one layer of the dielectric layer was visible. TEM was measured under conditions of an acceleration voltage of 200 kV using an Xe-FIB (focused ion beam) in an area of about 400 nm×400 nm in which at least one dielectric layer was visible in the active region. Subsequently, EDS (energy dispersive spectroscopy) analysis was performed on the TEM images of the measured cross-sectional samples.

FIGS. 6A to 6D are TEM-EDS (transmission electron microscope-energy dispersive spectroscopy) analysis images of a dielectric layer according to Example 1, and FIGS. 7A to 7D are TEM-EDS (transmission electron microscope-energy dispersive spectroscopy) analysis images of a dielectric layer according to Comparative Example 1.

Referring to FIGS. 6A to 6D, in Example 1, a small Dy content was detected at grain boundaries in the dielectric layer, and a secondary phase including Dy, Al, and Si was confirmed to be present at a triple point where three grain boundaries met one another. On the contrary, referring to FIGS. 7A to 7D, Comparative Example 1 was confirmed that Dy was distributed mainly at grain boundaries and that no secondary phase including Dy, Al and Si appeared.

### Evaluation 2: TCC Characteristics

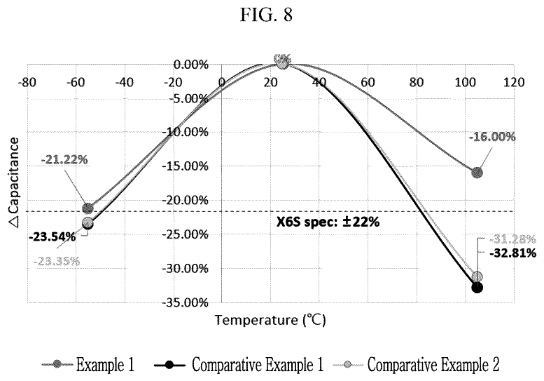

The multilayer ceramic capacitors according to Example 1 and Comparative Examples 1 and 2 were measured with respect to temperature coefficient of capacitance (TCC) characteristics, and the results are shown in FIG. 8 and Table 1.

Specifically, TCC was measured under conditions of 1 kHz, 0.01 V, and a holding time of 5 minutes.

TABLE 1

| | TCC (%) | | |
|---|---|---|---|
| | | Room temperature | |
| | −55° C. | (25° C.) | 105° C. |
| Example 1 | −21.22% | 0% | −16.00% |
| Comparative Example 1 | −23.54% | 0% | −32.81% |
| Comparative Example 2 | −23.35% | 0% | −31.28% |

FIG. 8 shows temperature coefficient of capacitance (TCC) graphs of the multilayer ceramic capacitors of Example 1 and Comparative Examples 1 and 2.

Referring to FIG. 8 and Table 1, Example 1, in which a secondary phase including Dy, Al, and Si existed at a triple point in the dielectric layer, and compared with Comparative Example 1, in which no secondary phase appeared, and Comparative Example 2, in which the Si secondary phase appeared, exhibited capacitance change of ±22% at low and high temperatures, compared with room temperature, and thereby, excellent TCC characteristics. This confirms that as solid-solution of an additive such as a rare earth element was suppressed, temperature characteristics such as TCC were improved. Accordingly, the multilayer ceramic capacitor according to an embodiment exhibited excellent TCC characteristics.

### Evaluation 3: Reliability

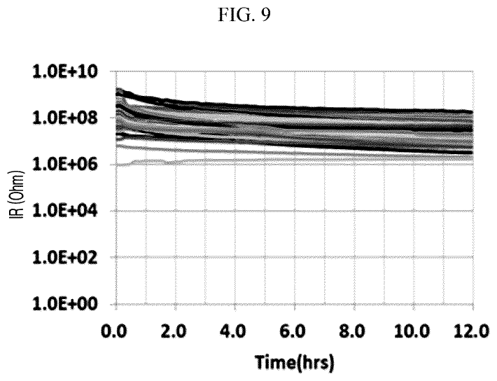

The multilayer ceramic capacitors according to Example 1 and Comparative Examples 1 and 2 were measured with respect to high-temperature stress reliability (HALT) and moisture resistance reliability, and the results are shown in FIGS. 9 to 14.

Specifically, the multilayer ceramic capacitors according to Example 1 and Comparative Examples 1 and 2 were manufactured respectively by 40 and then, mounted on a measurement substrate to measure the high-temperature stress reliability (HALT) by using ESPEC (PV-222, HALT) equipment under the conditions of 125° C., 12 hours, and 9.45 V and the moisture resistance reliability by using ESPEC (PR-3J, 8585) equipment under the conditions of 85° C., relative humidity (R.H.) of 85%, 9.45 V and 12 hours.

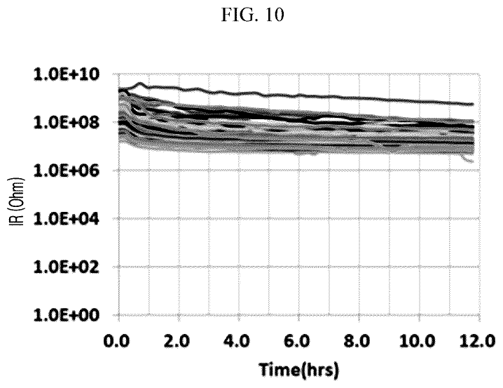

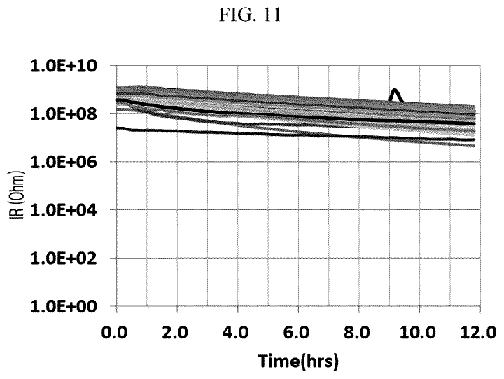

FIG. 9 is a graph showing the high-temperature stress reliability of a multilayer ceramic capacitor according to Example 1, FIG. 10 is a graph showing the high-temperature harsh reliability of the multilayer ceramic capacitor according to Comparative Example 1, and FIG. 11 is a graph showing the high-temperature stress reliability of a multilayer ceramic capacitor according to Comparative Example 2.

Referring to FIGS. 9 to 11, Example 1, in which a secondary phase including Dy, Al, and Si was present at a triple point in the dielectric layer, compared with Comparative Example 1 in which no secondary phase appeared, and Comparative Example 2, in which the Si secondary phase appeared, exhibited equivalent or higher high-temperature stress reliability. Accordingly, the multilayer ceramic capacitors according to an embodiment exhibited excellent high-temperature stress reliability.

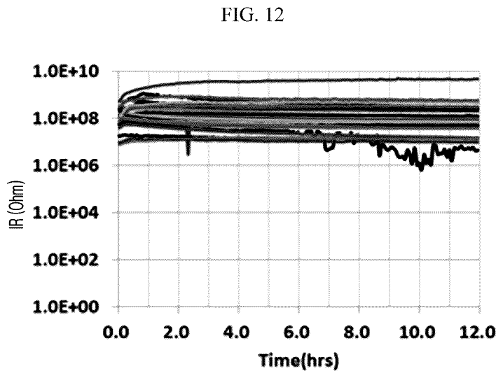

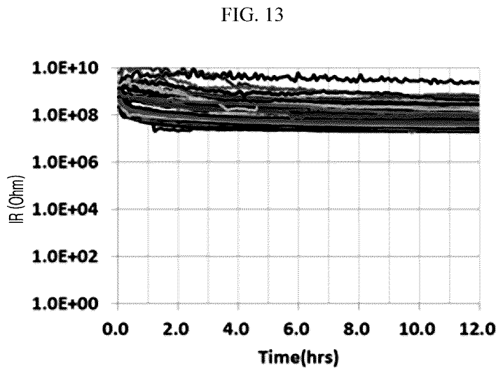

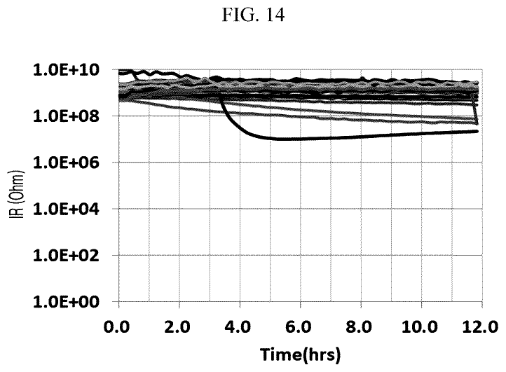

FIG. 12 is a graph showing the moisture resistance reliability of the multilayer ceramic capacitor according to Example 1, FIG. 13 is a graph showing the moisture resistance reliability of the multilayer ceramic capacitor according to Comparative Example 1, and FIG. 14 is a graph showing the moisture resistance reliability of the multilayer ceramic capacitor according to Comparative Example 2.

Referring to FIGS. 12 to 14, Example 1, in which a secondary phase including Dy, Al, and Si was present at a triple point in the dielectric layer, compared with Comparative Example 1, in which no secondary phase appeared, and Comparative Example 2, in which the Si secondary phase appeared, exhibited equivalent or higher moisture resistance reliability. Accordingly, the multilayer ceramic capacitor according to an embodiment exhibited excellent moisture resistance reliability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including a dielectric layer and an internal electrode layer, and
an external electrode disposed on an outside of the capacitor body,
wherein the dielectric layer comprises a plurality of dielectric grains, grain boundaries disposed between the plurality of dielectric grains, and a triple point where three grain boundaries are disposed in contact,
the dielectric layer includes a secondary phase disposed at the triple point, and
the secondary phase includes Dy, Al, and Si.

2. The multilayer ceramic capacitor of claim 1, wherein
the secondary phase includes Dy in an amount of 15 atomic % to 25 atomic % based on a total amount of atoms in the secondary phase.

3. The multilayer ceramic capacitor of claim 1, wherein
the secondary phase includes Al in an amount of 5 atomic % to 6 atomic % based on a total amount of atoms in the secondary phase.

4. The multilayer ceramic capacitor of claim 1, wherein
the secondary phase includes Si in an amount of 70 atomic % to 80 atomic % based on a total amount of atoms in the secondary phase.

5. The multilayer ceramic capacitor of claim 1, wherein
the dielectric layer comprises a barium titanate-based main component, and a subcomponent including Dy, Al, and Si.

6. The multilayer ceramic capacitor of claim 5, wherein
the subcomponent further comprises one or more elements selected from Tb, V, Mn, and Mg.

7. The multilayer ceramic capacitor of claim 5, wherein
Dy of the secondary phase is included in the dielectric layer in an amount of 0.95 parts by atom to 1.15 parts by atom based on 100 parts by atom of Ti in the barium titanate-based main component.

8. The multilayer ceramic capacitor of claim 5, wherein
Al of the secondary phase is included in the dielectric layer in an amount of 0.30 parts by atom to 0.34 parts by atom based on 100 parts by atom of Ti in the barium titanate-based main component.

9. The multilayer ceramic capacitor of claim 5, wherein
Si of the secondary phase is included in the dielectric layer in an amount of 4.0 parts by atom to 4.4 parts by atom based on 100 parts by atom of Ti in the barium titanate-based main component.

10. The multilayer ceramic capacitor of claim 1, wherein
an area occupied by the secondary phase is 0.15% to 1% of a total area of the dielectric layer.

11. The multilayer ceramic capacitor of claim 1, wherein, in the secondary phase, an amount of Al is less than an amount of Dy.

12. The multilayer ceramic capacitor of claim 1, wherein, in the secondary phase, an amount of Al is less than an amount of Si.

13. The multilayer ceramic capacitor of claim 1, wherein, in the secondary phase, an amount of Dy is less than an amount of Si.

14. A method of manufacturing a multilayer ceramic capacitor, comprising
mixing a barium titanate-based main component powder and a subcomponent powder including a Dy-containing compound, an Al-containing compound, and a Si-containing compound to prepare a dielectric slurry;
manufacturing a dielectric green sheet from the dielectric slurry and forming a conductive paste layer on a surface of the dielectric green sheet;
manufacturing a dielectric green sheet stack by stacking a plurality of the dielectric green sheets on which the conductive paste layer is formed;
manufacturing a capacitor body including a dielectric layer and an internal electrode layer by firing the dielectric green sheet stack; and
forming an external electrode on a surface of the capacitor body,
wherein the dielectric layer comprises a plurality of dielectric grains, grain boundaries disposed between the plurality of dielectric grains, and a triple point where three grain boundaries are disposed in contact,
the dielectric layer includes a secondary phase disposed at the triple point, and
the secondary phase includes Dy, Al, and Si.

15. The method of claim 14, wherein
the Dy-containing compound is mixed in an amount of 0.5 parts by mole to 1.2 parts by mole based on 100 parts by mole of the barium titanate-based main component powder.

16. The method of claim 14, wherein
the Al-containing compound is included in an amount of 0.1 parts by mole to 0.5 parts by mole based on 100 parts by mole of the barium titanate-based main component powder.

17. The method of claim 14, wherein
the Si-containing compound is included in an amount of 1 part by mole to 5 parts by mole based on 100 parts by mole of the barium titanate-based main component powder.

18. The method of claim 14, wherein
the subcomponent powder further comprises at least one selected from a Tb-containing compound, a V-containing compound, a Mn-containing compound, and a Mg-containing compound.

19. The method of claim 14, wherein
the firing is performed under a holding time of 10 seconds to 3 minutes.

20. The method of claim 14, wherein
the firing is performed at a temperature of 1160° C. to 1250° C.
